(19) United States
(12) Patent Application Publication
(10) Pub. No.: US 2014/0344072 A1
(43) Pub. Date: Nov. 20, 2014

(54) SYSTEM AND METHOD OF PERSONALIZED MARKETING

(71) Applicant: Jim Hughes, Weldon Spring, MO (US)

(72) Inventor: Jim Hughes, Weldon Spring, MO (US)

(21) Appl. No.: 14/279,305

(22) Filed: May 15, 2014

Related U.S. Application Data
(60) Provisional application No. 61/823,631, filed on May 15, 2013.

(51) Int. Cl. G06Q 30/02

(52) U.S. Cl. CPC G06Q 30/0271
USPC 705/14.67

(57) ABSTRACT

A system of personalized marketing having a computer system for administering a marketing program to prepare personalized marketing information based on a predetermined set of criteria, and a marketing device for distribution to consumers that displays the personalized marketing information.

### CROSS-REFERENCE TO RELATED APPLICATIONS

This application derives and claims priority from U.S. provisional Application Ser. No. 61/823,631, filed May 15, 2013, which is hereby incorporated by reference.

### STATEMENT REGARDING FEDERALLY SPONSORED RESEARCH

Not Applicable.

### BACKGROUND

The invention relates to system and method of personalized marketing, and more particularly to a system and method for providing a marketing device to a consumer with personalized marketing information.

### DESCRIPTION OF THE DRAWINGS

In the accompanying drawings which form part of the specification:

FIG. 1 a block diagram of a system for administrating a personalized marketing program in accordance with the present invention;

FIG. 2 is a sample of a front side of a personalized marketing device; and

FIG. 3 is a sample of a rear side of a personalized marketing device.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the claimed invention, describes several embodiments, adaptations, variations, alternatives, and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

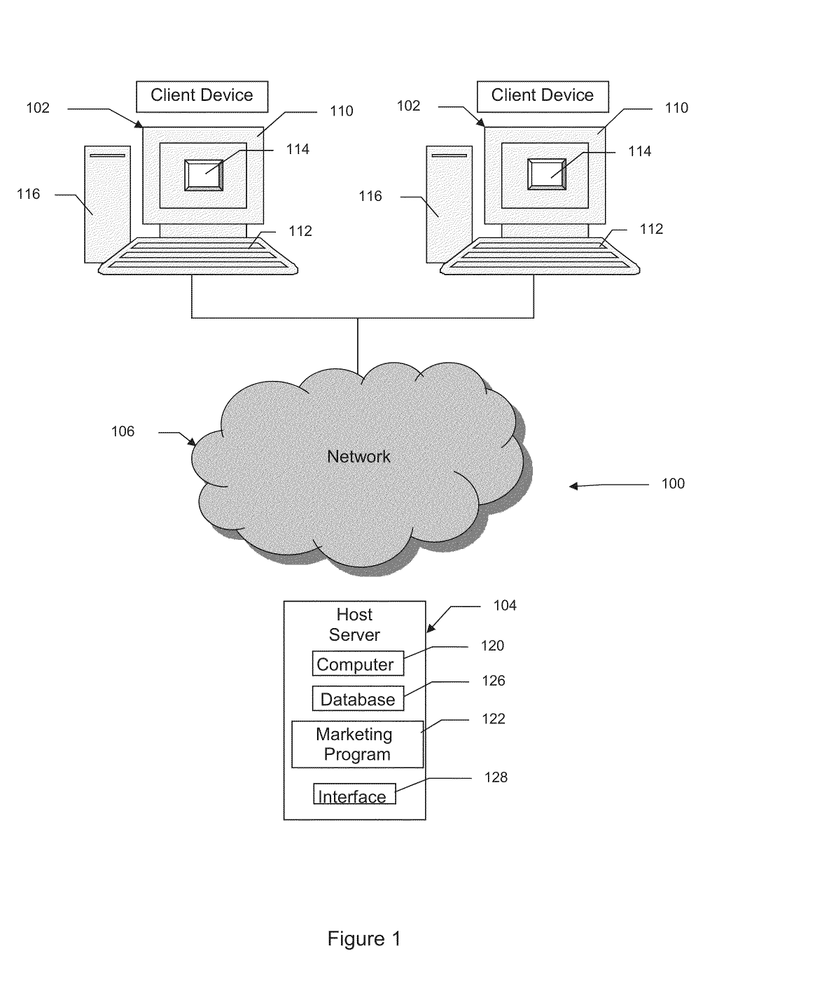

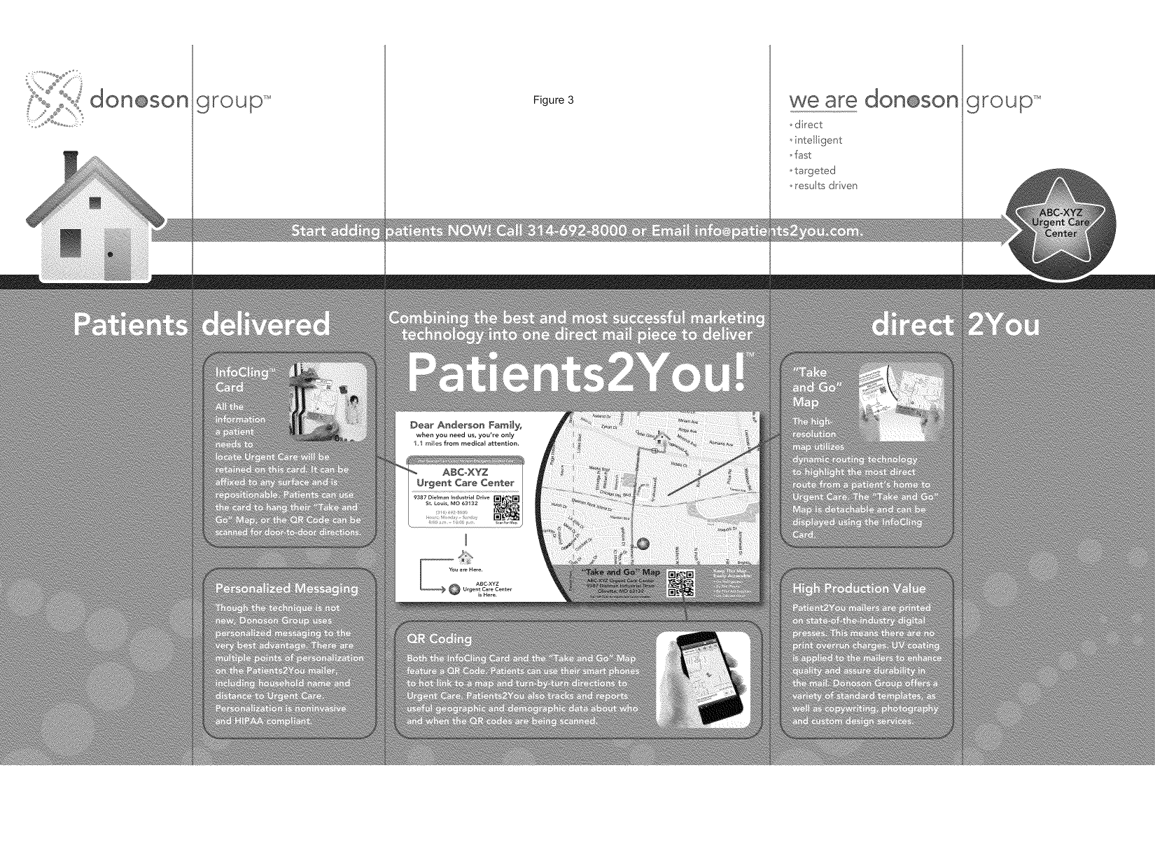

As shown in FIGS. 1-3, a system and method of personalized marketing, includes a marketing device 10 and a computer system 100. In the present embodiment, the marketing device 10 is a card shaped and sized for distribution, such as by mailing. The marketing device 10 includes a plurality of personalized information for the recipient including, but not limited to, a geo-processed map with visual directions, QR codes with hot link maps, a detachable map, a repositionable sticker, salutation, personalized text, icons, graphics, symbols, and the like.

As shown in FIG. 1, the system and method of personalized marketing utilizes a computer system 100 with at least one client device 102 operatively connected to at least one host server 104 through a communication network 106 to communicate data between the client device 102 and the host server 104. The computer system 100 is capable of administering a marketing program 122, which is described below in further detail. Generally, the marketing program 122 contains a plurality of features that allow retailers to prepare personalized marketing devices 10 for consumers based on predetermined criteria, such as the retailers location, discounts, graphics, logos, and the like. In addition, the marketing program 122 can provide data to the retailer, such as tracking and usage information.

In the embodiment of FIG. 1, the client device 102 is a computer 108, including a processor, memory, a mass storage device, a display device 110, and an input device 112, such as a keyboard, that is capable of running a network interfacing program 114, such as web browser software available, for example, from Netscape® Corporation, Apple® Corporation, or from Microsoft® Corporation. The client device 102 is appropriately equipped with a network interfacing device 116 for communicating data with the network 106, such as a dial-up modem, a cable modem, a satellite connection, a DSL (Digital Subscriber Line) connection, a LAN (Local Area Network), or the like. Alternate embodiments of client device 102 include any electrical or electronic device capable of communicating with the server 104 through the network 106, such as, for example, a personal digital assistant (PDA), cellular phone, a telephone operating with an interactive voice-system, or a television operating with a cable or satellite television interactive system.

The client device 102, can be used for entry of data in a text, video, or audio format via the keyboard, or other suitable input interface such as a mouse, microphone, touch screen, scanner, and the like. The network interfacing program 114 allows the user to enter addresses of specific web pages to be retrieved, which are referred to as Uniform Resource Locators, or URLs. The web pages can contain various types of content from plain textual information to more complex multimedia and interactive content, such as software programs, graphics, audio signals, videos, and so forth. A set of interconnected web pages, usually including a homepage, are managed on a server device as a collection collectively referred to as a website. The content and operation of such websites are managed by the server device, such as host server 104, which is operatively connected to the network 106.

For example, the marketing program 122 generates a web page, such as registration page 130 that transmits through the network 106 and displays on the display 110. In the preferred embodiment, the registration page 132 includes a plurality of data fields 134. The user interacts with the marketing program 122 by entering data with the input device 112. By selecting one of these options, the marketing program 122 generates additional web pages and interacts with the database 126 and the client device 102 in order to communicate data. The content and operation of such websites are managed by the server device, such as host server 104, which is operatively connected to the network 106.

In the embodiment of FIG. 1, the network 106 is the Internet, which uses a suitable communications protocol, such as HyperText Transfer Protocol (HTTP), to communicate data between the client devices 102 and the host server 104. However, the network 106 can be any network that allows an exchange of data between the client devices 102 and the host server 104, such as a LAN or WAN (Wide Area Network). In addition, any suitable type of communications protocol can be used, such as FTP (File Transfer Protocol), SNMP (Simple Network Management Protocol), TELNET (Telephone Network), and the like. Alternatively, the client device 102 can be directly connected to the host server 104 for communication of data.

The host server 104 preferably comprises a computer system 120, having a processor, memory, and a mass storage device, which is capable of running a marketing program 122. A database 126 is stored on the mass storage device. Also, the host server 104 is appropriately equipped with a network interfacing device 128 for communicating data with the network 106, such as a dial-up modem, a cable modem, a satellite connection, a DSL connection, a LAN, or the like. If necessary to accommodate large amounts of information or run numerous applications, alternate embodiments of the host server 104 can comprise multiple computer systems, multiple databases, or any combination thereof.

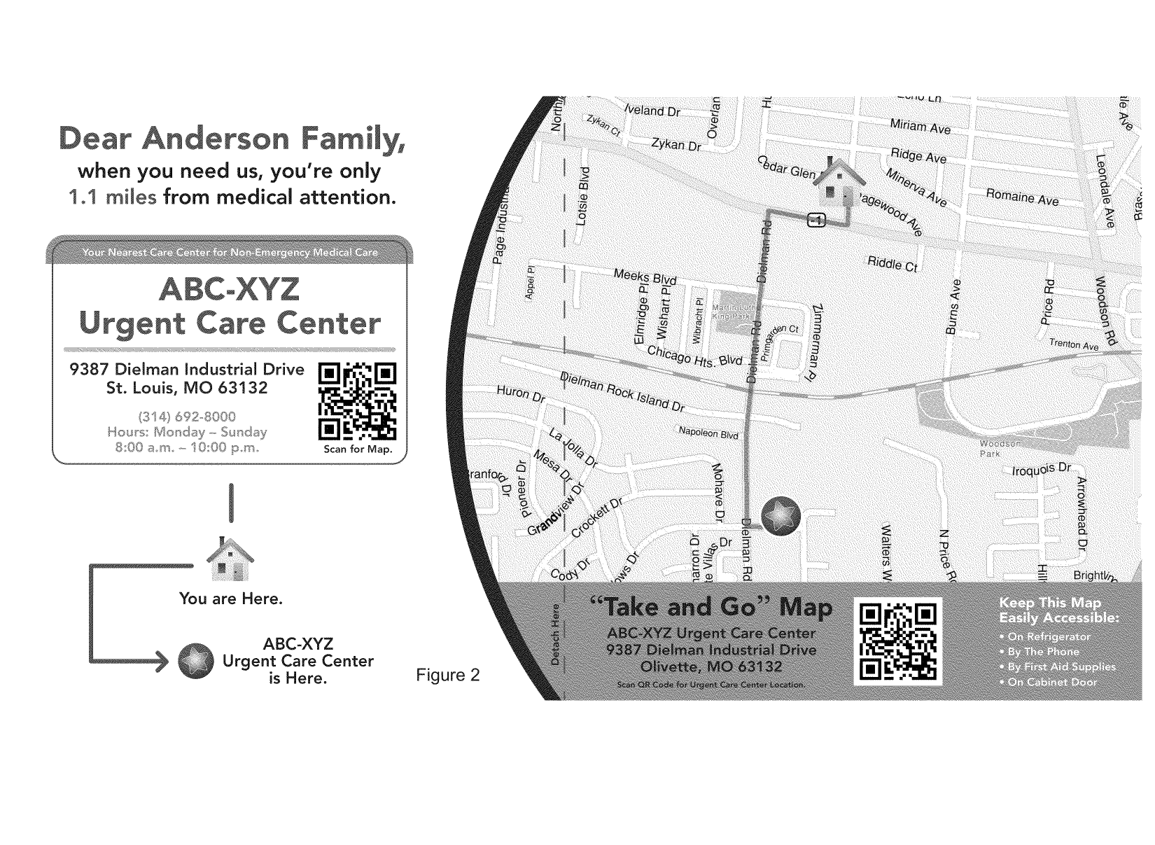

The marketing program 122 allows users through the interfacing program 114 of the client device 102 to access various features of the marketing program 122 on the host server 104. As shown in FIGS. 2, the marketing program 122 generates a web page, such as home page 140, that transmits through the network 106 and displays on the client device display 110 via the interfacing program 114. The user interacts with the marketing program 122 by entering data with the input device 112, in this case by selecting one of the options. By selecting one of these options, the marketing program 122 generates additional web pages and interacts with the database 126 and the client device 102 in order to provide the selected features to the user.

Those skilled in the art will recognize the marketing program 122 can provide access to any number of options and features, which may include, but are not limited to tracking code usage (e.g. QR code, bar code, Blipper. Microsoft tag, MaxiCode, EZ Code, Data Matrix, and the like), preparation of personalized maps, networking features, bulletin boards, chat room, retail and commercial sales, database searches, and other web applications.

Changes can be made in the above constructions without departing from the scope of the invention, it is intended that all matter contained in the above description or shown in the accompanying drawings shall be interpreted as illustrative and not in a limiting sense.

What is claimed is:

1. A system of personalized marketing, comprising:
a computer system for administering a marketing program to prepare personalized marketing information based on a predetermined set of criteria; and
a marketing device for distribution to consumers that displays the personalized marketing information.

2. A system comprising any feature described, either individually or in combination with any feature, in any configuration for the system described in the specification and figures for a system of personalized marketing.

3. A process to create and comprising any process described, in any order, using any modality described in the specification and figures for a system of personalized marketing.

4. A method to use and comprising any process described, in any order, using any modality described in the specification and figures for a system of personalized marketing.
